(19) United States
(12) Patent Application Publication
(10) Pub. No.: US 2008/0192374 A1
(43) Pub. Date: Aug. 14, 2008

(54) TEST METHOD AND APPARATUS FOR TUNNELING MAGNETORESISTIVE ELEMENT

(75) Inventor: Masato Matsubara, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 12/005,852

(22) Filed: Dec. 28, 2007

(30) Foreign Application Priority Data
Feb. 8, 2007 (JP) 2007-028686

(51) Int. Cl. G11B 27/36

(52) U.S. Cl. 360/31

(57) ABSTRACT

A reproduction-element test method for a reproduction element that utilizes a tunneling magnetoresistive effect includes a measurement step for measuring first and second resistance values for different currents, a comparison step for comparing a resistance value differential curve that is calculated from a theoretical equation between tunneling magnetoresistiance and a voltage of the reproduction element of a non-defective article having the same design, with a resistance changing rate calculated from the first and second resistance values measured by the measurement step; and a determination step for determining whether the reproduction element is defective or non-defective based on a comparison between the resistance value differential curve and the resistance changing rate.

This application claims the right of a foreign priority based on Japanese Patent Application No. 2007-028686, filed on Feb. 8, 2007, which is hereby incorporated by reference herein in its entirety as if fully set forth herein.

### BACKGROUND OF THE INVENTION

The present invention relates generally to a test method for a reproduction element or read device, and more particularly to a test method for a tunneling magnetoresistive (“TMR”) element. The present invention is suitable, for example, for a test method of a TMR (head) element used for a hard disc drive (“HDD”).

Along with the Internet etc., a HDD that stably reproduces a large amount of information has been increasingly demanded. As the disc's surface recording density becomes higher in order to meet the demand for a large capacity, a signal magnetic field becomes weaker. A smaller and more highly sensitive reproduction element is necessary to read this weak signal magnetic field.

A known candidate of this reproduction element is a TMR element that has a TMR film. The TMR film is configured to hold an insulation film between two magnetic films, and to flow the tunneling current perpendicular to a lamination surface. However, any pinholes in the insulation film and any shortcircuits around the insulation film would lower the resistance of the TMR head, and deteriorate the reproduction output or the sensitivity. Therefore, the TMR head's performance test has conventionally been performed by measuring a resistance value of the TMR film. In addition, another known method determines whether or not there is a pinhole by calculating a resistance changing rate ΔR/R of the TMR head (see, for example, Japanese Patent Publication Application No. 2006-66873.) In the meantime, the resistance does not become completely 0 even when there is a shortcircuit, and this application can refer to the resistance having a shortcircuit as “shortcircuit resistance.” With high shortcircuit resistance, the insulation film can work to some extent. However, when the shortcircuit resistance is low, the sensitivity of the TMR film lowers.

FIG. 1 shows a relationship between the voltage and the tunnel magnetoresistance of the TMR film. W. F. Brinkman, R. C. Dynes, J. M. Rowell, J. Appl. Phys. 41 1951 (1970). While the normal resistance is linear to the current according to the Ohm's law, the TMR film depicts a nonlinear relationship between the resistance and the voltage (R-V curve).

However, the conventional method cannot effectively determine whether a TMR element having a shortcircuit is defective or non-defective. Firstly, since resistance values of TMR films scatter due to the process, the method that utilizes the resistance value cannot precisely determine whether the head is defective or non-defective based on the shortcircuit. Secondly, the method that utilizes the resistance changing rate can determine the filming quality based on a presence of a pinhole in the TMR film, but cannot determine whether the head is defective or non-defective based on the shortcircuit.

### BRIEF SUMMARY OF THE INVENTION

The present invention is directed to a test method and apparatus that can effectively determine whether a TMR element is defective or non-defective.

A reproduction-element test method according to one aspect of the present invention for a reproduction element that utilizes a tunneling magnetoresistive effect includes a measurement step for measuring first and second resistance values for different currents, a comparison step for comparing a resistance value differential curve that is calculated from a theoretical equation between tunneling magnetoresistiance and a voltage of the reproduction element of a non-defective article having the same design, with a resistance changing rate calculated from the first and second resistance values measured by the measurement step, and a determination step for determining whether the reproduction element is defective or non-defective based on a comparison between the resistance value differential curve and the resistance changing rate. This test method can determine whether the reproduction element is defective or non-detective based on the shortcircuit resistance. The resistance value differential curve may be obtained by connecting a resistor having a specific resistance value in parallel to the non-defective article, based on the theoretical equation between the tunneling magnetoresistance and the voltage of the reproduction element of the non-defective article, and the determination step may determine that the reproduction element is non-defective when an absolute value of the resistance changing rate is higher than the resistance value differential curve. The specific resistance value is, for example, 1,000 O. The theoretical equation between the tunneling magnetoresistance and the voltage may be derived from a Brinkman's theoretical equation. The determination step may determine that the reproduction element is non-defective when the resistance changing rate of the reproduction element is close to the resistance value differential curve. The first resistance value may be obtained when 0.1 mA is flowed in the reproduction element, the second resistance value may be obtained when 0.4 mA is flowed in the reproduction element, and the resistance changing rate may be a value that is made by subtracting the first resistance value from a second resistance value, by dividing a subtraction result by the first resistance value, and by multiplying a division result by 100. A permissible resistance range of the reproduction element is, for example, between 300 O and 400 O.

A reproduction-element test apparatus according to another aspect of the present invention for a reproduction element that has a tunneling magnetoresistive effect includes a measurement part that measures first and second resistance values for different currents, a comparison part that compares a resistance value differential curve that is calculated from a theoretical equation between tunneling magnetoresistance and a voltage of the reproduction element of a non-defective article having the same design, with a resistance changing rate calculated from the first and second resistance values measured by the measurement part, and a determination part that determines whether the reproduction element is defective or non-defective based on a comparison between the resistance value differential curve with the resistance changing value. This test apparatus can determine whether the reproduction element having a shortcircuit is defective or non-detective.

A computer-implemented program that enables a computer to execute the above reproduction-element test method also constitutes another aspect of the present invention.

Other objects and further features of the present invention will become readily apparent from the following description of the preferred embodiments with reference to accompanying drawings.

### BRIEF DESCRIPTION OF THE DRAWINGS

FIG. 1 is a graph showing a relationship between the voltage and the resistance of a TMR film.

FIG. 2 is a plane view of a test apparatus according to one embodiment of the present invention.

FIG. 3 is a flowchart for explaining a test method according to one embodiment of the present invention.

FIG. 4 is a graph used for the test method shown in FIG. 3.

FIG. 5 is a graph used for the test method shown in FIG. 3.

FIG. 6 is a plane view of an HDD onto which a head gimbal assembly shown in FIG. 1 is mounted.

FIG. 7 is a schematic enlarged plane view of a magnetic head part shown in FIG. 6.

### DETAILED DESCRIPTION OF THE PREFERRED EMBODIMENTS

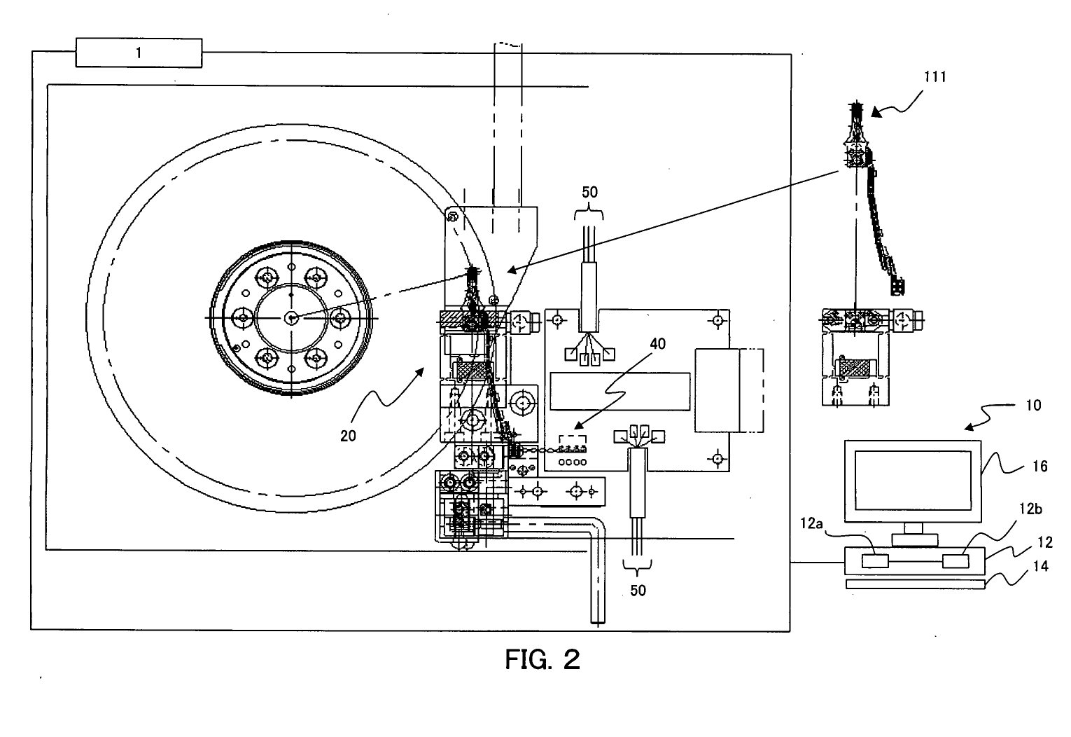

Referring now to FIG. 2, a description will be given of a test apparatus 1 for a magnetic head device for use with a HDD (storage) 100, which will be described later. The test apparatus 1 includes a personal computer (“PC”) 10, a mount member 20 to be mounted with a head gimbal assembly (“HGA”) 111 to be tested, a detector 40, and a current supply unit 50. The HGA 111 is a suspension assembly mounted with a slider, and can be referred to as a head suspension assembly.

The test apparatus 1 is a test apparatus that determines whether a HGA 111 is a defective article or a non-defective article, before the HGA 111 is mounted onto the HDD 100. As described later, the HGA 111 includes a magnetic head part 120, and the magnetic head part 120 includes a recording element (inductive head device 130) used to write information in a disc 104, which will be described later, and a reproduction element (TMR head device 140) used to read the information from the disc 104. The test apparatus 1 tests both the recording element and the reproduction element, and outputs a result relating to whether each of them is defective or non-defective while correlating their IDs, but this embodiment will discuss only a test method of the reproduction element.

The PC 10 controls an operational mode of the test apparatus 1, and outputs and stores a test result. The PC 10 of this embodiment is part of the test apparatus 1, but may be connected to the test apparatus 1 through via a network in another embodiment. The PC 10 includes a PC body 12, an input part 14, such as a keyboard and a mouse, and an output part 16, such as a display. The PC body 12 includes a controller 12a, such as a CPU, and a memory 12b. The controller 12a performs various operations and determinations necessary for the test method. The memory 12b stores the test method and various data necessary for it. An operational mode of the test apparatus 1 is implemented as a software program and stored in the memory 12b, and a user can select an operational mode through the controller 12a and the input part 14 viewing the output part 16.

The mount member 20 is mounted with the HGA 111. When the HGA 111 is mounted on the mount member 20, the current supply unit 50 supplies the current to a reproduction element in the HGA 111. The detector 40 detects the resistance of the TMR element while the current supply unit 50 electrifies the HGA 111. The information detected by the detector 40 is sent to the controller 12a in the PC 10.

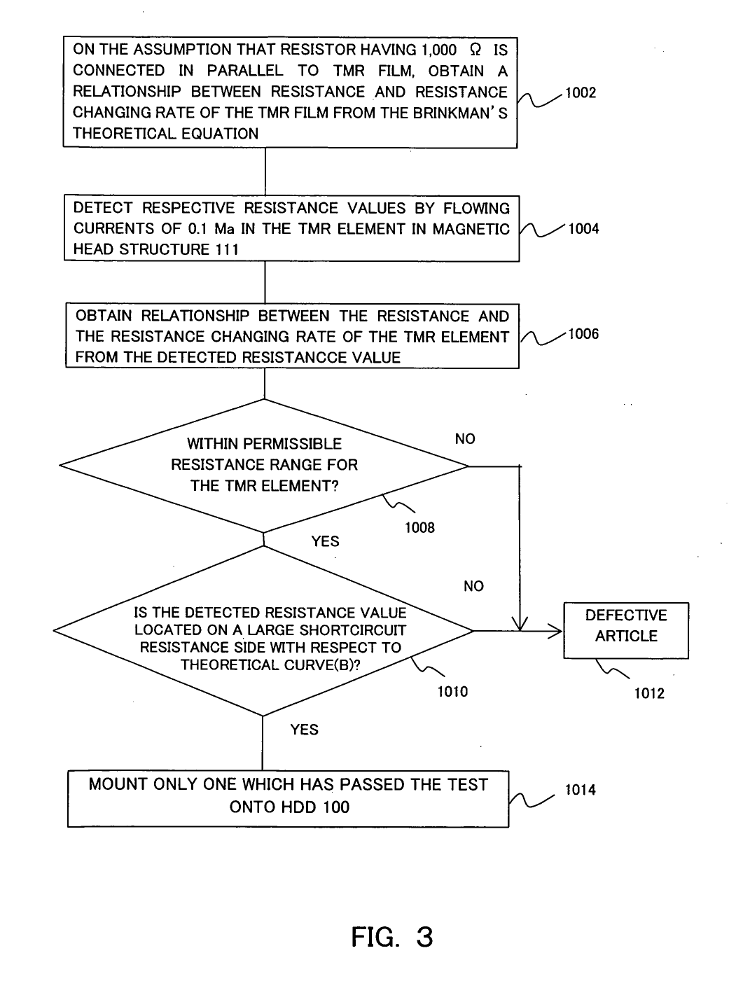

Referring now to FIG. 3, a description will be given of an operation of the test apparatus 1. Here, FIG. 3 is a flowchart for explaining a test method of this embodiment. The test method shown in FIG. 3 is implemented as a program executed by the PC 100. Initially, on the assumption that a resistor having a resistance value of 1,000 O is connected in parallel to the TMR film, the controller 12a obtains a relationship between the resistance and the resistance changing rate from a Brinkman's theoretical equation (step 1002). This is the step of obtaining the theoretical curve (b), which will be described later.

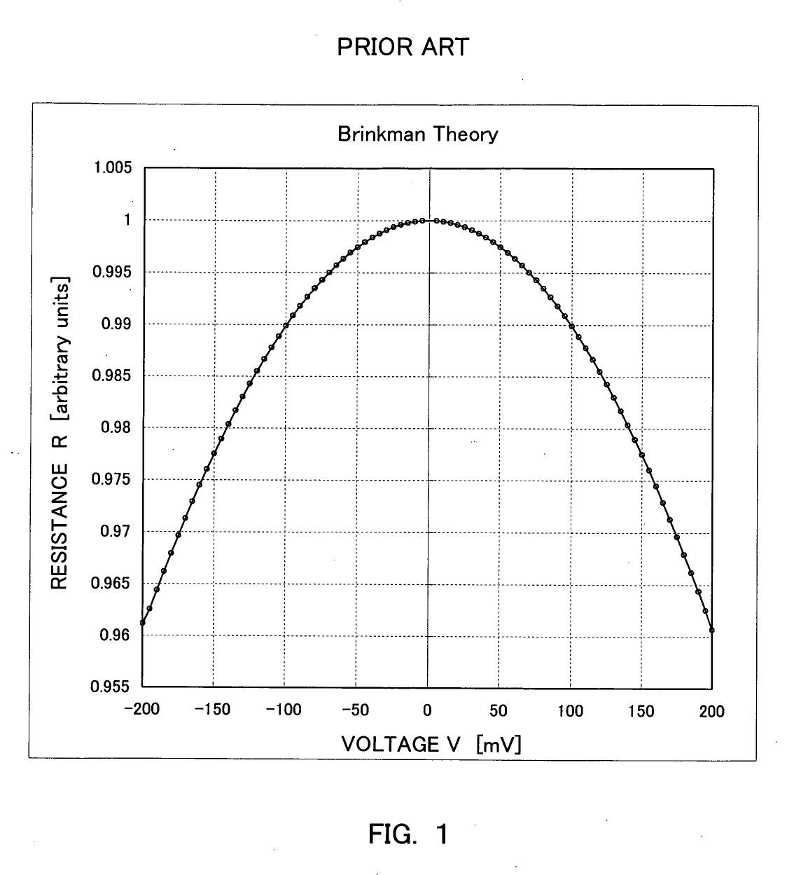

It is premised that the memory 12b previously stores a relationship between the voltage and the resistance of the TMR film shown in FIG. 1 and the Brinkman's theoretical equation given below and in the above reference, where Δφ=φ₂−φ₁,

$${A}_{0} = 4 {( 2 m )}^{1 / 2} \frac{d}{3 ℏ} ,$$

φ₁ and φ₂ are barrier heights on respective interfaces, and d is a thickness of an insulation film:

$$\frac{G ( V )}{G ( 0 )} = 1 - ( \frac{{A}_{0} Δϕ}{16 {ϕ}^{2 / 3}} ) e V + ( \frac{9}{128} \frac{{A}_{0}^{2}}{ϕ} ) {( e V )}^{2} \qquad [ EQUATION 1 ]$$

The memory 12 also stores the resistance changing rate ΔR/R defined in Equation 2 below:

$$\frac{Δ R}{R} = \frac{R ( 0.4 mA ) - R ( 0.1 mA )}{R ( 0.1 mA )} \times 100 \qquad [ EQUATION 2 ]$$

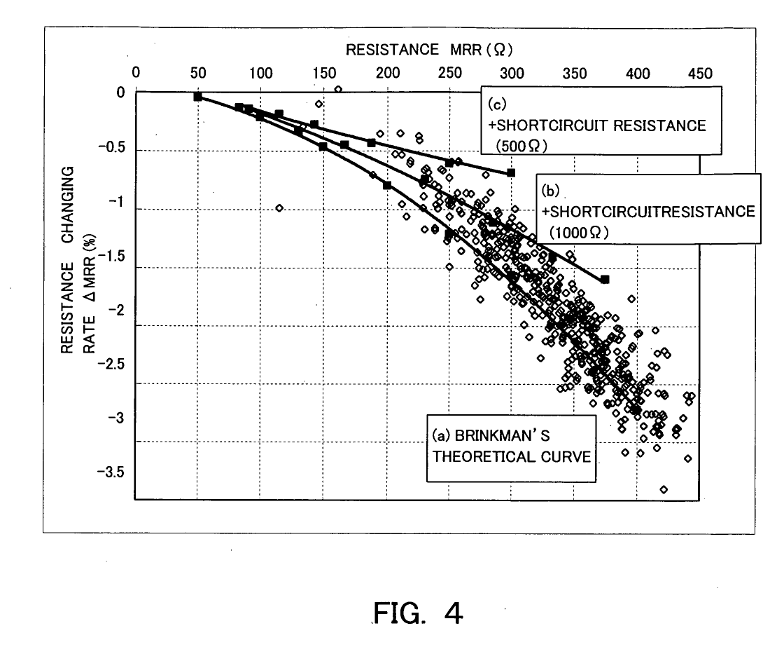

The Brinkman's theoretical equation is normalized so that the resistance value of the ordinate axis becomes 1 when the voltage is 0. On the other hands, the actual TMR element's resistance value ranges between 300 O and 400 O. Therefore, the user inputs a parameter value necessary for the actual TMR element in Equation 1. The controller 12a utilizes the input value and Equation 2 and obtains theoretical or ideal curve (a) shown in FIG. 4.

0.1 mA and 0.4 mA are used to calculate the resistance changing rate, but the present invention is not limited to these current values. These current values provide a large resistance changing rate, fall upon a safe range that does not break the TMR film, and are empirically obtained by this inventor. The theoretical curve (a) is an ideal curve on the basis of the resistance of 400 O and the resistance changing rate of −3% when a (shortcircuit) resistor connected in parallel to the TMR film's resistor has the resistance of indefinite.

Next, through the input part 14, the user inputs a permissible minimum shortcircuit resistance value for the shortcircuit part when the TMR film is shortcircuited, and the controller 12a sets an input shortcircuit resistance value. The instant inventor has discovered that it is empirically near 1,000 O. Next, the controller 12b calculates as theoretical curve (b) an ideal curve of a model in which the resistor of 1,000 O is assumed to be connected in parallel to the TMR film depicted by the theoretical curve (a). For reference, FIG. 4 also shows as theoretical curve (c) an ideal curve of a model in which a resistor having 500 O is assumed to be connected in parallel to the TMR film depicted by the theoretical curve (a). Since the theoretical curve (c) is located above the theoretical curve (b), it is understood that the upper side of the ideal curve (b) corresponds to the side having a shortcircuit resistance value smaller than a resistance value of 1,000 O. The memory 12b stores the graph shown in FIG. 4 that draws at least the theoretical curve (b).

Next, the controller 12a instructs the current supply unit 50 to flow the currents of 0.1 mA and 0.4 mA in the TMR element in the magnetic head structure (or HGA) 111, and the detector 40 to detect the resistance value of the TMR element for each current value (step 1004).

Next, the controller 12a obtains a detection result from the detector 40, and thereby obtains a relationship between the resistance and the resistance changing rate of the TMR element to be tested (step 1006). The step 1006 is to plot detection results by the detector 40 in FIG. 4. The abscissa axis denotes a resistance value when the current of 0.1 mA is flowed in the TMR element. The ordinate axis denotes a value that is made by subtracting a resistance value when the current of 0.1 mA is flowed in the TMR element from a resistance value when the current of 0.4 mA is flowed in the TMR element, by dividing the subtraction result by the resistance value when the current of 0.1 mA is flowed, and by multiplying a division result by 100. FIG. 4 plots rhombic detection results by the detector 40.

Next, the controller 12a determines whether the relationship obtained in the step 1006 falls upon a permissible resistance range for the TMR element (step 1008). The permissible resistance range for the non-defective TMR element with the same design falls between 300 O and 400 O from the experience of the instant inventor.

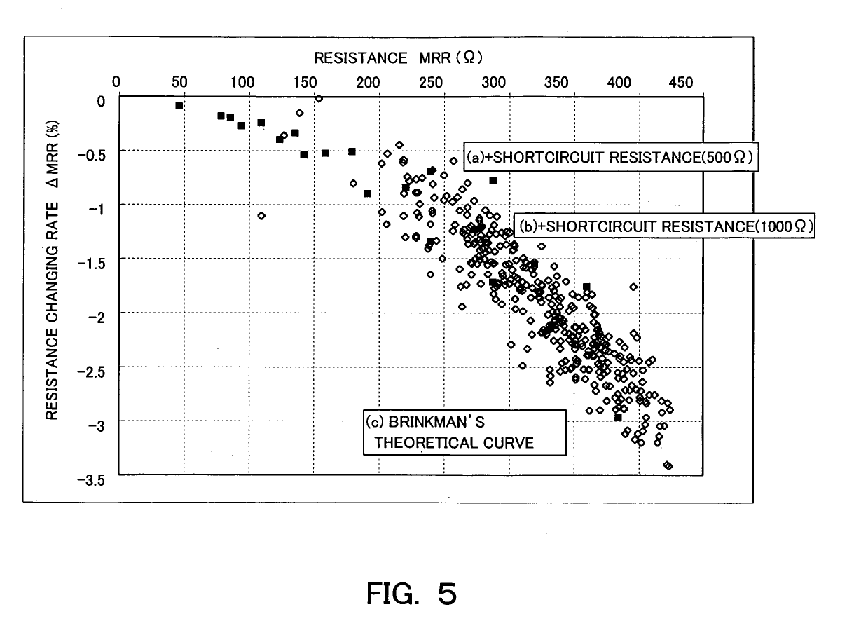

When the controller 12a determines that the relationship obtained in the step 1006 falls in the permissible resistance range for the TMR element (step 1008), then the controller 12a determines whether the detected resistance value is located on a larger shortcircuit resistance side with respect to the theoretical curve (b) (step 1010). The detected resistance value is located on the larger shortcircuit resistance side with respect to the theoretical curve (b) when it is located under the theoretical curve (b) in FIG. 4. After all, the pass zone that satisfies two conditions of the steps 1008 and 1010 is beveled part shown in FIG. 5.

While this embodiment tests utilize the theoretical curve (b) having the permissible minimum shortcircuit resistance value, the test may consider non-defective the TMR film having a resistance changing value near the upper or lower side of the theoretical curve (a).

The TMR element determined negative in the step 1008 or 1010 is determined to be a defective article (step 1012). The non-defective articles will next undergo a reading performance test, and only those which pass the reading performance test will be mounted on the HDD 100 (step 1014). The test of this embodiment has not conventionally been performed, and all products have been subject to the reading performance test. On the other hands, when only those which passed the test of this embodiment underwent the reading performance test, a ratio of the products that pass the reading performance test or the yield improved by about 10%.

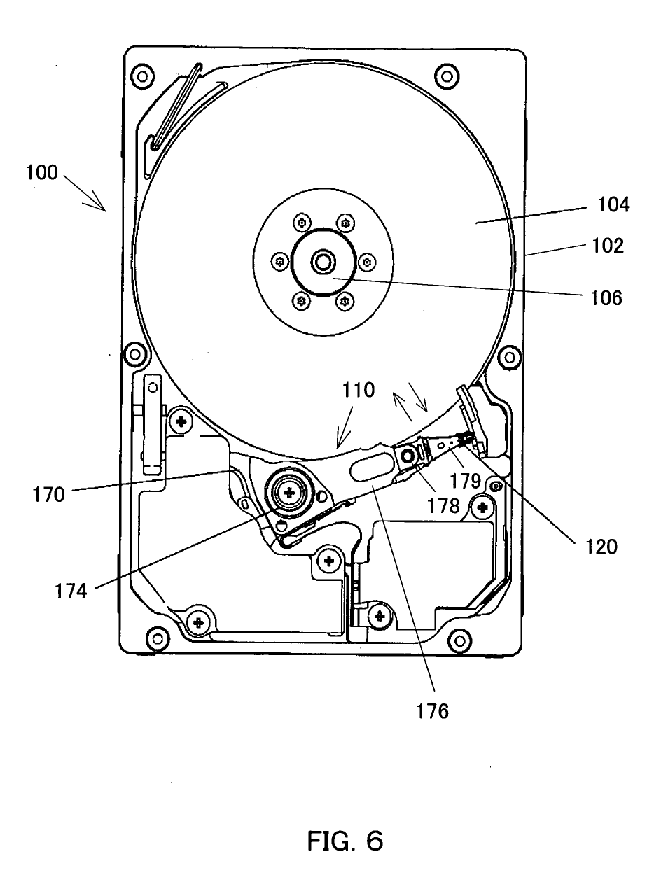

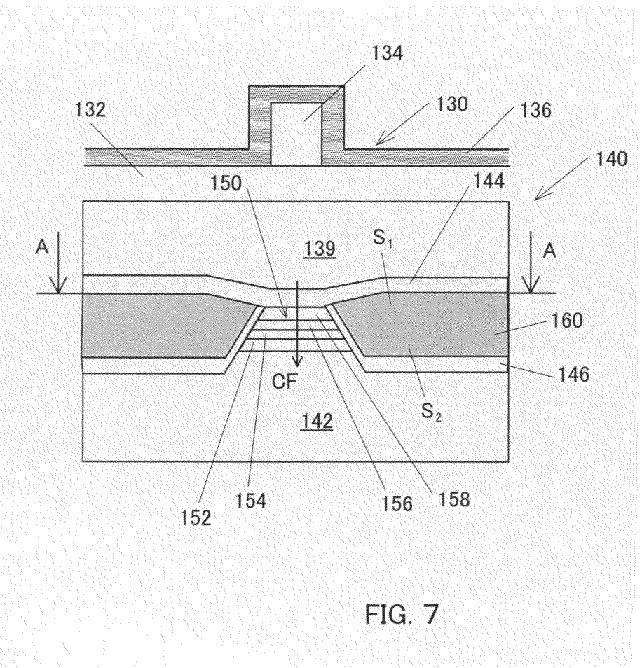

Referring now to FIGS. 6 and 7, a description will be given of an HDD 100 after the HGA 111 is mounted on the HDD 100. The HDD 100 includes, as shown in FIG. 6, one or more magnetic discs 104 each serving as a recording medium, a spindle motor 106, and a head stack assembly (“HSA”) 110 in a housing 102. The HGA 111 constitutes part of the HAS 110. Here, FIG. 6 is a schematic plane view of the internal structure of the HDD 100.

The housing 102 has a rectangular parallelepiped shape to which a cover (not shown) that seals the internal space is jointed. The magnetic disc 104 has such a high recording density as 100 Gb/in² or greater. The magnetic disc 104 is mounted on a spindle (hub) of the spindle motor 106 through its center hole of the magnetic disc 104.

The HSA 110 includes a magnetic head part 120, a carriage 170, a base plate 178, and a suspension 179.

The magnetic head part 120 includes a slider, and a magnetic read/write head connected to the air outflow end of the slider. The slider supports the head and floats above the rotating disc surface. The head records information in and reproduces the information from the disc 104.

FIG. 7 is an enlarged plane view of the head. The head is, for example, a MR inductive composite head that includes an inductive write head device (“inductive head device” hereinafter) 130 that writes binary information in the magnetic disc 104 utilizing the magnetic field generated by a conductive coil pattern, and a magnetoresistive (“MR”) head that has a MR head element 140 that reads the binary information based on the resistance that varies in accordance with the magnetic field applied by the magnetic disc 104.

The inductive head device 130 includes a nonmagnetic gap layer 132, an upper magnetic pole layer 134, an Al₂O₃ film 136, and an upper shield-upper electrode layer 139. The upper shield-upper electrode layer 139 also forms part of the TMR head device 140. The TMR head device 140 includes the upper shield layer 139, a lower shield layer 142, an upper gap layer 144, a lower gap layer 146, a TMR film 150, and a pair of hard bias films 160 arranged at both sides of the TMR film 150. The TMR film 150 includes, in this order from the bottom in FIG. 7, a free (ferromagnetic) layer 152, a (nonmagnetic) insulation layer 154, a pinned (magnetic) layer 156, and an antiferromagnetic layer 158. The TMR film has a ferromagnetic tunneling junction that holds the insulation layer 154 between a pair of ferromagnetic layers, and utilizes a tunneling phenomenon in which electrons in the ferromagnetic layer on the minus side escape the insulation layer and reach the ferromagnetic layer on the plus side. The insulation layer 154 utilizes, for example, an Al₂O₃ film. The TMR head device 140 has a CPP structure that applies the sense current perpendicular to laminated surfaces or parallel to the lamination direction in the TMR film 150, as depicted by an arrow CF.

Turning back to FIG. 6, the carriage 170 serves to rotate or swing the magnetic head part 120 in arrow directions shown in FIG. 1, and includes a shaft 174, and an arm 176. The shaft 174 is engaged with a cylindrical hollow in the carriage 170, and arranged perpendicular to the paper plane in the housing 102 shown in FIG. 1. The arm 176 has a perforation at its top. The suspension 179 is attached to the arm 176 via the perforation and the base plate 178.

The base plate 178 serves to attach the suspension 179 to the arm 176. The suspension 179 serves to support the magnetic head part 120 and to apply an elastic force to the magnetic head part 120 against the magnetic disc 104.

In operation of the HDD 100, the spindle motor 106 rotates the disc 104. The airflow associated with the rotation of the disc 104 is introduced between the disc 104 and slider, forming a fine air film and thus generating the floating force that enables the slider to float over the disc surface. The suspension 179 applies an elastic compression force to the slider in a direction opposing to the floating force of the slider, forming the balance between the floating force and the elastic force.

This balance spaces the magnetic head part 120 from the disc 104 by a constant distance. Next, the carriage 170 is rotated around the shaft 174 for head 122's seek for a target track on the disc 104. In writing, data is received from the host (not shown) such as a PC through an interface and modulated and supplied to the inductive head device 130 so as to write the data in the target track via the inductive head device 130. In reading, the TMR head device 140 is supplied with the predetermined sense current, and reads desired information from a desired track on the disk 104. This embodiment sorts the TMR head device 140 having high shortcircuit resistance, and can stabilize a readout action of the HDD 100.

Further, the present invention is not limited to these preferred embodiments, and various modifications and variations may be made without departing from the spirit and scope of the present invention.

What is claimed is:

1. A reproduction-element test method for a reproduction element that utilizes a tunneling magnetoresistive effect, said reproduction-element test method comprising:
a measurement step for measuring first and second resistance values for different currents;
a comparison step for comparing a resistance value differential curve that is calculated from a theoretical equation between tunneling magnetoresistiance and a voltage of the reproduction element of a non-defective article having the same design, with a resistance changing rate calculated from the first and second resistance values measured by said measurement step; and
a determination step for determining whether the reproduction element is defective or non-defective based on a comparison between the resistance value differential curve and the resistance changing rate.

2. A reproduction-element test method according to claim 1, wherein the resistance value differential curve is obtained by connecting a resistor having a specific resistance value in parallel to the non-defective article, based on the theoretical equation between the tunneling magnetoresistance and the voltage of the reproduction element of the non-defective article, and
wherein the determination step determines that the reproduction element is non-defective when an absolute value of the resistance changing rate is higher than the resistance value differential curve.

3. A reproduction-element test method according to claim 2, wherein the specific resistance value is 1,000 O.

4. A reproduction-element test method according to claim 1, wherein the theoretical equation between the tunneling magnetoresistance and the voltage is derived from a Brinkman's theoretical equation.

5. A reproduction-element test method according to claim 1, wherein the determination step determines that the reproduction element is non-defective when the resistance changing rate of the reproduction element is close to the resistance value differential curve.

6. A reproduction-element test method according to claim 1, wherein the first resistance value is obtained when 0.1 mA is flowed in the reproduction element, the second resistance value is obtained when 0.4 mA is flowed in the reproduction element, and the resistance changing rate is a value that is made by subtracting the first resistance value from a second resistance value, by dividing a subtraction result by the first resistance value, and by multiplying a division result by 100.

7. A reproduction-element test method according to claim 1, wherein a permissible resistance range of the reproduction element is between 300 O and 400 O.

8. A reproduction-element test apparatus for a reproduction element that has a tunneling magnetoresistive effect, said reproduction-element test apparatus comprising:
a measurement part that measures first and second resistance values for different currents;
a comparison part that compares a resistance value differential curve that is calculated from a theoretical equation between tunneling magnetoresistance and a voltage of the reproduction element of a non-defective article having the same design, with a resistance changing rate calculated from the first and second resistance values measured by said measurement part; and
a determination part that determines whether the reproduction element is defective or non-defective based on a comparison between the resistance value differential curve with the resistance changing value.
